(19) United States
(12) Patent Application Publication
(10) Pub. No.: US 2009/0196752 A1
(43) Pub. Date: Aug. 6, 2009

(54) METHOD FOR STOPPING A WIND TURBINE

(75) Inventor: Michael FRIEDRICH, Silkeborg (DE)

Correspondence Address: LADAS & PARRY LLP, 26 WEST 61ST STREET, NEW YORK, NY, 10023, US

(73) Assignee: GAMESA INNOVATION & TECHNOLOGY, S.L.

(21) Appl. No.: 12/360,126

(22) Filed: Jan. 27, 2009

(30) Foreign Application Priority Data
Jan. 31, 2008 (ES) ES200800252

(51) Int. Cl. F03D 7/00

(52) U.S. Cl. 416/147; 416/1

(57) ABSTRACT

A method for stopping a pitch controlled wind turbine comprising at least one blade and a pitch system for adjusting the blade pitch angle, the pitch system allowing turning said at least one blade towards the feathered position or towards the fine position, that includes the step of turning said at least one blade towards the feathered position or towards the fine position so that the blade loads are minimized. Said step is carried on taking into account the state of one or more of the following operational conditions: the blade pitch angle, the blade angle of attack, the wind velocity, the blade loads.

### FIELD OF THE INVENTION

The invention relates to a method for stopping a wind turbine and more in particular to a method for stopping a wind turbine depending on one or more operational conditions of the wind turbine.

### BACKGROUND

Wind turbines are devices that convert mechanical energy to electrical energy. A typical wind turbine includes a nacelle mounted on a tower housing a drive train for transmitting the rotation of a rotor to an electric generator.

The efficiency of a wind turbine depends on many factors. One of them is the orientation of the rotor blades with respect to the direction of the air stream, which is usually controlled by a pitch system that allows adjusting the pitch angle of the rotor blades for maintaining the rotor's speed at a constant value or within a given range. Otherwise, specially at high wind speeds, the load of the rotor will exceed the limits set by the wind turbine's structural strength.

There are two basic methods for controlling the power of a wind turbine changing the pitch angle of the rotor blades: the “pitch” control method and the “stall” control method.

In the “pitch” control method the rotor blade's pitch angle is changed to a smaller angle of attack in order to reduce power capture and to a greater angle of attack to increase the power capture. This method allows a sensitive and stable control of the aerodynamic power capture and rotor speed.

In the “stall” control method the rotor blade's pitch angle is changed to a greater angle of attack to the point where the flow separates at the rotor blade's surface, thus limiting the aerodynamic power capture.

The stopping of a wind turbine is one of the most critical operations because it may involve high loads for the wind turbine components.

In pitch controlled wind turbines, the stopping operation includes the step of pitching the blades with the trailing edge pointing along the wind until they reach their feathered position. This step may involve large loads in the blades specially when the stopping operation is started at high angles of attack.

In stall controlled wind turbines, the stopping operation includes the step of pitching the blades with the trailing edge pointing against the wind until they reach their fine position. This step may involve large loads in the blades specially when the stopping operation is started at low angles of attack.

These two options are not fully satisfactory and the present invention is intended to solve this drawback.

### SUMMARY OF THE INVENTION

An object of the invention is to provide an improved method for stopping a pitch controlled wind turbine minimizing the blade loads.

Another object of the invention is to provide an improved method for stopping a pitch controlled wind turbine when one of the wind turbine blades is blocked.

These and other objects of the present invention are met by providing a method for stopping a pitch controlled wind turbine comprising at least one blade and a pitch system for adjusting the blade pitch angle, the pitch system allowing turning said at least one blade towards the feathered position or towards the fine position, that includes the step of turning said at least one blade towards the feathered position or towards the fine position so that the blade loads are minimized.

In one embodiment the method for stopping a pitch controlled wind turbine when one blade is blocked includes the step of turning the other blade or blades towards the fine position. Hereby a load efficient stopping method is achieved specially for two-blades wind turbines.

Other features and advantages of the present invention will be understood from the following detailed description in relation with the enclosed drawings.

### BRIEF DESCRIPTION OF DRAWINGS

FIG. 1 shows the lift and drag on a wind turbine blade as function of the angle of attack.

FIG. 2 shows schematically the lift on the blades of a two-blades wind turbine when it is stopped pitching the blades towards the feathered position having one blade blocked.

FIG. 3 shows schematically the lift on the blades of a two-blades wind turbine when it is stopped pitching the blades towards the fine position having one blade blocked.

### DETAILED DESCRIPTION OF PREFERRED EMBODIMENTS

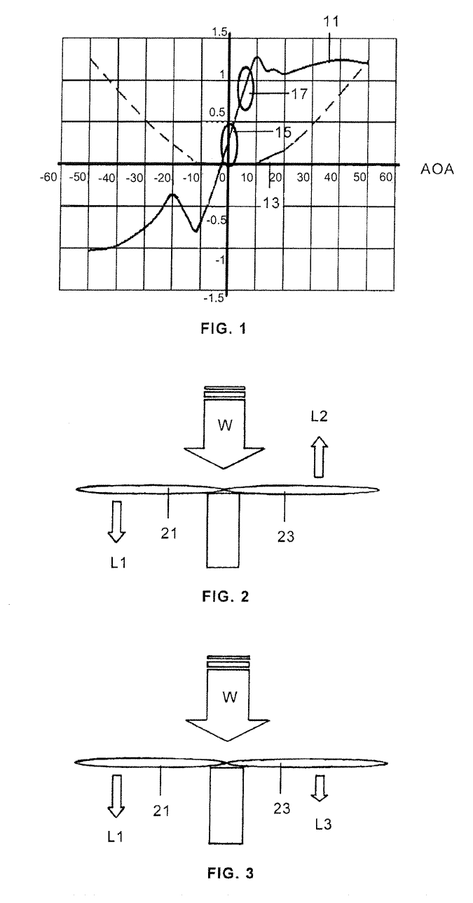

As it can be seen in FIG. 1 the lift 11 and drag 13 actuating on a blade depends on the angle of attack AOA.

If the stopping operation of a pitch controlled wind turbine is initiated when it is operating with the blades in zone 15 in FIG. 1, i.e. at a low AOA, the blades are moved towards negative AOA and hence the blades will deflect forward. In the same situation, in the stopping operation of a stall controlled wind turbine the blades are moved towards positive AOA and hence the blades will have the maximum lift 11 and hereby possible large deflections.

If the stopping operation of a pitch controlled wind turbine is initiated when it is operating with the blades in zone 17 in FIG. 1, i.e. at a high AOA, the blades are moved towards negative AOA and hence the blades will deflect forward. In the same situation, in the stopping operation of a stall controlled wind turbine the blades are moved towards positive AOA and hence the lift 11 will remain on the blades but drag 13 will stop the rotation speed and hence the lift 11 will also decrease.

According to the present invention, in the same situation, the stopping operation is carried out pitching the blades towards the fine position when the blades are in zone 17 and towards the feathered position when the blades are in zone 15.

In more general terms, the stopping operation according to the present invention, which is applicable to wind turbines having one or more blades, is carried out pitching the wind turbine blade(s) towards the feathered or the fine position depending on one or more of the following operational conditions: the blade pitch angle, the blade angle of attack, the wind velocity, the loads on the blade and the blade turning capability.

One requirement of the method of the present invention is that the wind turbine comprise an electric pitch system with a gear and a tooth ring on the blade bearing or any other system that provides the blades with a full turning capability of 180 deg.

The present invention is particularly advantageous for dealing with situations in which one blade is blocked, specially in the case of two-blades wind turbines.

In the case of a shut down of a typical pitch controlled wind turbine having two blades 21, 23, when one blade 21 is blocked, the sequence of a stopping operation is the following: Initially both blades 21, 23 moved by wind W are operated at a typical AOA for the profiles along the blade of, for example, 10 deg and hence will have positive lift L1 generating the thrust and the along bending of the blades 21, 23, Then, blade 23 is pitched towards negative AOA and hence will have a negative lift L2 giving blade 23 bending opposite the other blade 21, as shown in FIG. 2, generating very high and damaging yaw and tilt moments.

However, in the same situation, according to the stopping method of the present invention, the blade 23 is pitched towards positive AOA and therefore lift L3 will reach initially a maximum value, then it will decrease a little and the drag force of the blade 23 will slow down the rotation. The lift L3 is a function of velocity squared (L=½*rho*V̂2*CL*A) and as the rotor is slowed down by the drag force from the active pitching blade, the relative velocity on the blade 23 is decreased and hence the lift L3 removed slowly. Hence, as shown in FIG. 3, the lift direction of the blades 21, 23 remain in same direction during the stopping, but only the magnitude of the lift can vary during the stopping and hence the yaw and tilt loads are not expected to be so severe, because there is no unbalance in the rotor plane.

For a two-blades wind turbine the danger of having one blade blocked is the absolute worst load case, or at least a very severe load case. The loads reduction allowed by the method according to the present invention improves the competitiveness of two-blade wind turbines is some segments of the wind turbines market.

For all types of wind turbines the present invention is advantageous because it provides the possibility of pitching the blades in both directions, being taken the pitching direction decision when the need arises taking into account the relevant operational condition. For example:

If one blade is blocked the wind turbine blades are pitched towards the fine position.

If the wind velocity is comprised between 10-14 m/s, the blades are pitched towards the fine position.

If the pitch angle is less than 10 deg, the blades are pitched towards the fine position.

If the pitch angle is above 10 deg, the blades are pitched towards the feathered position.

Although the present invention has been fully described in connection with preferred embodiments, it is evident that modifications may be introduced within the scope thereof, not considering this as limited by these embodiments, but by the contents of the following claims.

1. A method for stopping a pitch controlled wind turbine comprising at least one blade and a pitch system for adjusting the blade pitch angle, the pitch system allowing turning said at least one blade towards the feathered position or towards the fine position, characterized in that includes the step of turning said at least one blade towards the feathered position or towards the fine position so that the blade loads are minimized.

2. A method for stopping a wind turbine according to claim 1, characterized in that said at least one blade is turned towards the feathered position or towards the fine position depending on the state of one or more of the following operational conditions: the blade pitch angle, the blade angle of attack, the wind velocity, the blade loads.

3. A method for stopping a wind turbine according to claim 2, characterized in that said at least one blade is turned to the fine position in the following situations:
when the wind velocity is comprised between 10-14 m/s;
when the pitch angle is lesser or equal to 10 deg.

4. A method for stopping a wind turbine according to claim 2, characterized in that said at least one blade is turned to the feathered position when the pitch angle is greater than 10 deg.

5. A method for stopping a wind turbine according to claim 1, characterized in that the wind turbine comprises two or more blades and in that when one of the blades is blocked the other blade or blades are turned towards the fine position.
